(19) United States
(12) Patent Application Publication
(10) Pub. No.: US 2005/0136976 A1
(43) Pub. Date: Jun. 23, 2005

(54) System and method for dynamically handling wireless telephone calls

(75) Inventor: Matthew B. Shoemake, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/744,656

(22) Filed: Dec. 23, 2003

(51) Int. Cl. H04B 1/38

(52) U.S. Cl. 455/557

(57) ABSTRACT

A wireless telephone handset (10) having an answer-and-wait operating mode is disclosed. When the answer-and-wait mode is activated, incoming calls have their caller ID information displayed and, in response to a key press or other input from the user, the call is answered and a wait message is transmitted to the caller, indicating that the call will be answered shortly. This permits the user to move to an appropriate location for the call; upon another key press or other input from the user, the call can then be taken and the conversation can take place. The activation of the answer-and-wait mode may be effected manually, or automatically through the use of a global positioning system (GPS) receiver (28) or in response to a signal from a wireless access point (50).

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of wireless telephone communications, and is more specifically directed to user functionality in wireless telephone handsets.

The prevalence of wireless telephones in modern society, both in industrialized countries and also in developing countries, has exploded over recent years. Much of the increased deployment of this technology is due to recent technological advances that have enabled higher quality telephone reception at lower costs. In combination with these improved communications technologies, the computing power now available in conventional wireless telephone handsets has also greatly increased, with handsets now being capable of relatively complex computations not only in the digital processing of telephonic communications, but also in providing added functionality for the handset user. For example, modern wireless telephone handsets now provide graphical user interfaces (GUI), and applications programs such as email clients, web browsers, digital photography, and the like.

Regardless of the complexity and power of its ancillary functions, wireless telephone handsets are still primarily telephones, for carrying out audio conversations by way of telephone calls. Calls are initiated, even from modern wireless telephone handsets, by the “dialing” of a telephone number, and the receipt of a call is still indicated, even by modern wireless telephone handsets, by the “ringing” of the telephone. In modern wireless telephone handsets, as is well known, the ringing function may be carried out by the playing of a selected stored sound pattern, or silently by actuating a vibrator or flashing a light. The silent mode can be selectably enabled by the considerate user in situations when audible ringing would be distracting to others, such as in meetings, church services, theaters, classrooms, restaurants, and the like. Of course, not all users are considerate, nor do even considerate users always remember to place their wireless telephone handsets in silent mode; as such, the ringing of wireless telephones (and, unfortunately, the subsequent answering and carrying out of a conversation) in inappropriate times and places is not uncommon.

Typically, if a telephone call is received at a time or place in which the user does not want to carry out the conversation, the user will permit the call to “roll over” into an answering system, such as voice mail. As is well known in the art, conventional voice mail stores messages left by callers when the call is not answered. The called party then retrieves the stored message (typically from the wireless telephone service provider) at a later time and in a different place.

It has been observed, in connection with this invention, that there are incoming calls that the wireless telephone handset user would like to answer, but that cannot be answer because the user is in a situation in which the carrying out of a telephone conversation would be rude or otherwise inappropriate. The need to take the call may be determined, by the recipient, by referring to the displayed “Caller ID” information on the phone, or by answering the call to the extent necessary to identify the caller. Call recipients that leave a meeting or other function in order to answer an incoming call are often observed. According to conventional techniques, however, the recipient of the call must first answer the call, and begin the conversation with the caller, if only to tell the caller to hold the line for a brief time until the recipient can leave the current location. Even this action on the part of the call recipient may be inappropriate in some situations; in addition, the caller may not hear that the recipient has answered, and may hang up before the recipient is able to leave and audibly answer the call.

By way of further background, the use of a “Decline” feature in a wireless telephone handset is known. This feature permits the recipient of an incoming call to view the Caller ID information for the call, and based on the Caller ID, to “decline” answering the all so that the calling party is immediately forwarded to voice mail for the recipient.

By way of further background, global positioning systems (GPS) are known; conventional GPS devices can precisely determine their location, by the triangulation of signals from satellites in geosynchronous orbit. By way of further background, wireless local area networks (LANs) are also known; wireless LANs provide communication with computing devices, for example, that are in the proximity of a wireless access point.

### BRIEF SUMMARY OF THE INVENTION

It is therefore an object of this invention to provide a wireless telephone handset, and method of operation, that enables the silent answering of an incoming call, and hold the call for a brief duration, until the call recipient can leave his or her current location to take the call.

It is a further object of this invention to provide such a handset and method in which the user can enable the answering and holding upon receipt of the call.

It is a further object of this invention to provide such a handset and method in which the handset senses that it is in a location in which the answering of a call is inappropriate, and automatically answers and holds incoming calls in such locations.

Other objects and advantages of this invention will be apparent to those of ordinary skill in the art having reference to the following specification together with its drawings.

The present invention may be implemented into a wireless telephone handset having an answer-and-wait function. The answer-and-wait function may be enabled by the user enabling a mode of operation, or automatically by the handset receiving a wireless proximity-determining signal indicating that it is in a location appropriate for answer-and-wait, or the handset may have the answer-and-wait function permanently enabled. Upon receipt of an incoming call, the user actuates the enabled answer-and-wait function, so that the incoming call is answered and placed on hold for a brief duration, permitting the recipient user to move to an appropriate location and then take the call.

### BRIEF DESCRIPTION OF THE SEVERAL VIEWS OF THE DRAWING

FIG. 1 is an elevation view of a wireless telephone handset according to the preferred embodiment of the invention.

FIG. 2 is an electrical diagram, in block form, of the wireless telephone handset of FIG. 1 according to the preferred embodiment of the invention.

FIG. 3 is a flow chart illustrating a method of operating the wireless telephone handset of FIGS. 1 and 2 according to the preferred embodiment of the invention.

FIG. 4 is a proximity diagram illustrating an alternative implementation of the answer-and-wait function according to the preferred embodiment of the invention.

### DETAILED DESCRIPTION OF THE INVENTION

The present invention will be described in connection with its preferred embodiment, namely as implemented into a cellular or wireless telephone handset and telephone network, because it is contemplated that this invention is of particular benefit in such an application. However, it is also contemplated that variations on the described embodiment of this invention, and other alternative implementations and systems, besides those described in this specification, will also benefit from this invention. Accordingly, it is to be understood that the following description is provided by way of example only, and is not intended to limit the true scope of this invention as claimed.

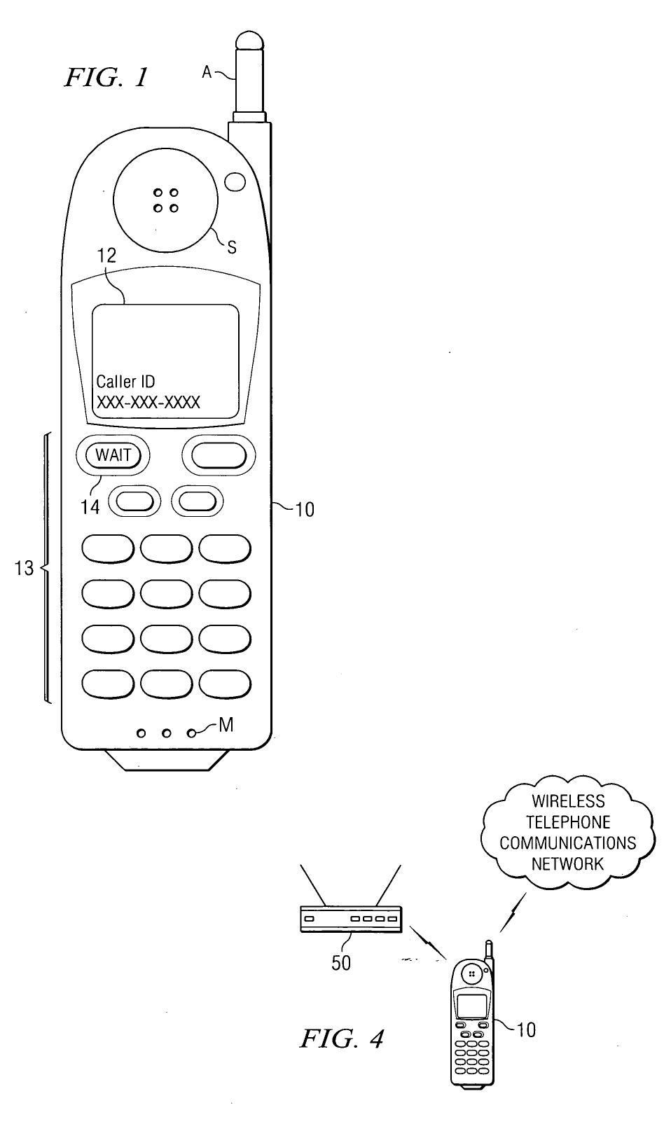

FIG. 1 illustrates an external view of wireless telephone handset 10 constructed according to the preferred embodiment of the invention. As shown in FIG. 1, handset 10 provides the conventional human interface features, including microphone M, speaker S, visual display 12, and keypad 13. Keypad 13 includes the usual keys for a wireless telephone handset, including numeric keys 0 through 9, the * and # keys, and other conventional keys (on-hook, off-hook, menu, etc.) as in conventional wireless telephone handsets. According to the preferred embodiment of the invention, keypad 13 of handset 10 also includes wait key 14, which is used to actuate and control an answer-and-wait function that will be described in further detail below.

Wait key 14 may be a single key, as shown in FIG. 1 according to this embodiment of the invention, or may alternatively be implemented as a set of multiple keys in which individual keys are assigned to various events in the answer-and-wait function as will become apparent from this description; further in the alternative, wait key 14 may be not a separate physical key or keys, but may instead be implemented by a menu-driven system operating in combination with one or more of the other keys of keypad 13 when in a particular operating mode as displayed by visual display 12.

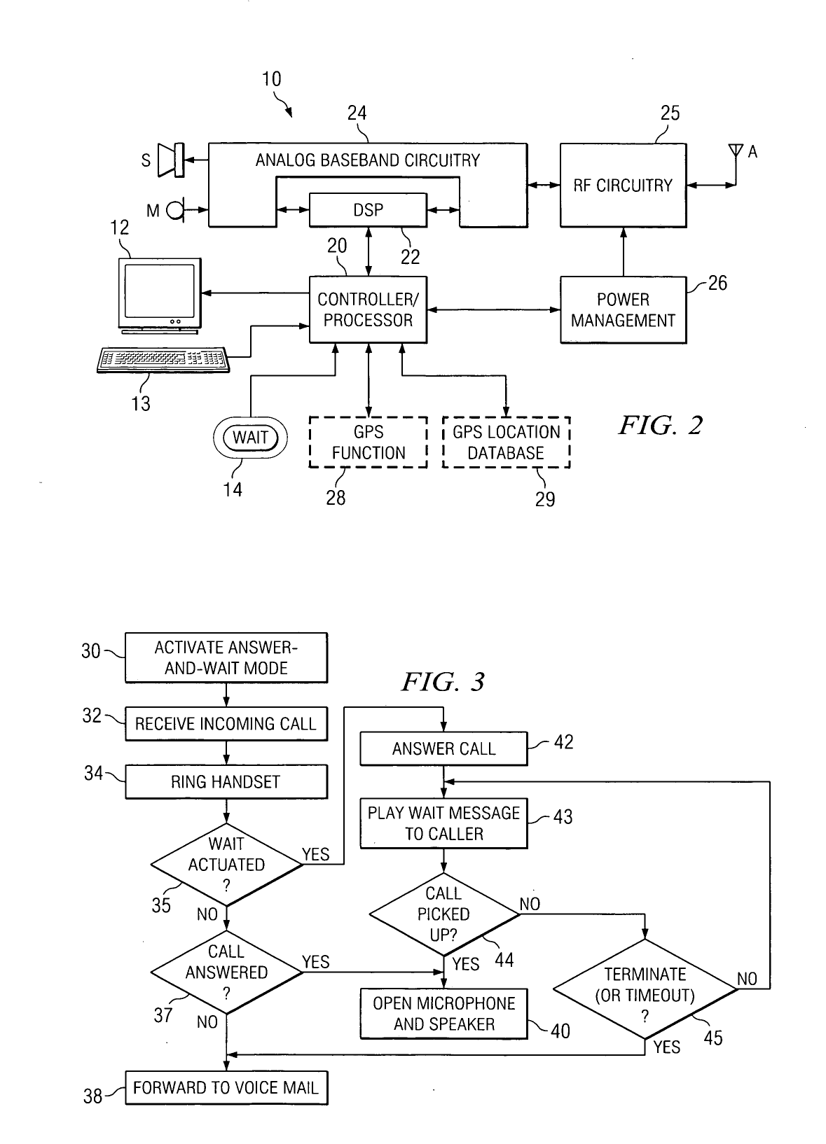

Referring now to FIG. 2, the construction of an exemplary architecture for handset 10 according to this preferred embodiment of the invention will now be described. Of course, the particular architecture of a wireless handset using this invention may vary from that illustrated in FIG. 2, and as such the architecture of FIG. 2 is presented here by way of example only.

As shown in FIG. 2, the functionality of handset 10 is primarily controlled by controller/processor 20. Controller/processor 20 is preferably a programmable logic device, such as a microprocessor or microcontroller, that controls the operation of handset 10 according to a computer program or sequence of executable operations stored in program memory. Preferably, the program memory is on-chip with controller/processor 20, but may alternatively be implemented in read-only memory (ROM) in a separate integrated circuit. The computational capability of controller/processor 20 depends on the level of functionality required of handset 10, including the “generation” of wireless services for which handset 10 is to be capable. As known in the art, modern wireless telephone handsets can have a great deal of functionality, including the capability of Internet web browsing, email handling, digital photography, and the like. High-performance processors that are suitable for use as controller/processor 20 include the OMAP processors available from Texas Instruments Incorporated.

In this example, controller/processor 20 is coupled to visual display 12, keypad 13, power management function 26, and digital signal processor (DSP) 22. Power management function 26 distributes regulated power supply voltages to various circuitry within handset 10, and manages functions related to charging and maintenance of the battery of handset 10, including standby and power-down modes to conserve battery power. DSP 22 performs the bulk of the digital signal processing for signals to be transmitted and signals received by handset 10. These functions include the necessary digital filtering, coding and decoding, digital modulation, and the like. Examples of DSPs suitable for use as DSP 22 in handset 10 according to this embodiment of the invention include the TMS320c6x family of digital signal processors available from Texas Instruments Incorporated.

Handset 10 also includes radio frequency (RF) circuitry 25, which is coupled to antenna A and to analog baseband circuitry 24. RF circuitry 25 includes such functions as necessary to transmit and receive the RF signals at the specified frequencies to and from the wireless telephone communications network. RF circuitry 25 is thus contemplated to include such functions as modulation circuitry (e.g., QPSK modulation and demodulation circuitry), and RF input and output drivers. Analog baseband circuitry 24 processes the signals to be transmitted (as received from microphone M) prior to modulation, and the received signals (to be output over speaker S) after demodulation (hence in the baseband), to apply the necessary filtering, coding and decoding, and the like. Typical functions included within analog baseband circuitry 24 include an RF coder/decoder (“codec”), a voice codec, speaker amplifiers, and the like, as known in the art.

According to the preferred embodiment of the invention, wait key 14 is also provided within handset 10, and is in communication with controller/processor 20 in similar fashion as the other keys of keypad 13. As mentioned above, wait key 14 may be a single dedicated key, a set of multiple keys in which individual keys are assigned to various events in the answer-and-wait function, or, further in the alternative, may correspond to a menu-driven function of controller/processor 20 operating in combination with one or more of the other keys of keypad 13.

Referring now to FIG. 3, the operation of handset 10 in providing an answer-and-wait function, according to the preferred embodiment of the invention, will now be described. This description will be presented from the viewpoint of the operation of handset 10; those skilled in the art having reference to this specification will recognize that this operation of handset 10 is in cooperation with the wireless telephone communications network in which handset 10 resides. As such, certain functions or operations may be provided by the communications network, rather than handset 10; indeed, some functions may be provided in either of handset 10 and the network. In addition, this operation of handset 10 will be described as performed by controller/processor 20 executing a sequence of instructions; of course, the particular integrated circuit device and the manner of operation of handset 10 in performing these functions will depend upon the architecture of handset 10. As such, this description is presented by way of example only.

In process 30, the answer-and-wait mode in handset 10 is activated. It is contemplated that activation process 30 can be accomplished by any one of a number of techniques. Ultimately, the purpose of the answer-and-wait mode is to enable the user of handset 10 to answer an incoming call, and to place that incoming call into a wait or hold state without speaking. Once handset 10 is in this wait state, the user can leave his or her location, at which the carrying out of a telephone conversation would be inappropriate, and then pick up the call again when the user is in an appropriate location.

Accordingly, it is contemplated that one way in which activation process 30 can be effected is by the user selecting an operating mode of handset 10. For example, the setting and use of “profiles” or “modes” of wireless telephone handsets is well known; example of these profiles and modes include a “silent” mode (in which the handset does not ring, and perhaps vibrates or flashes a light rather than rings), a “quiet” mode (in which the handset issues one relatively low volume signal instead of a ring), and the like. Similarly, activation process 30 according to this embodiment of the invention may be carried out by the user issuing keypad commands to controller/processor 20, preferably via a menu-driven interface, to select a profile or mode in which the answer-and-wait feature described below is enabled, or activated. Activation process 30 may be performed upon the user entering a location, such as a restaurant, church, theater, meeting room, or the like, in which telephone calls and conversations would be inappropriate. Alternatively, activation process 30 may be performed once by the user (or, further in the alternative, by the manufacturer or service provider), with handset 10 left in the answer-and-wait mode permanently or semi-permanently (i.e., as a default condition on power-up), if desired.

Other alternative methods for carrying out activation process 30 in a more automatic manner may also be used. Referring back to FIG. 2, handset 10 may optionally contain GPS function 28, which is a conventional Global Positioning System (GPS) receiver. As known in the art, a GPS receiver receives signals from multiple satellites, and by triangulation, can determine its location with good precision. According to this alternative implementation of activation process 30, GPS function 28 of handset 10 determines its location according to conventional GPS methods. Handset 10 also includes GPS location database 29, which is a local memory (within handset 10) that stores the coordinates of locations in which the use of a wireless telephone has been deemed inappropriate. Process 30 is then carried out beginning with the determination of the current GPS location of handset 10 by GPS receiver 28. Controller/processor 20 then compares the current location of handset 10 as received by GPS receiver 28 with the contents of GPS location database 29 to determine whether handset 10 is currently in an inappropriate location. If so, controller/processor 20 then places handset 10 into the answer-and-wait mode. Alternatively, GPS location database 29 may be stored by the service provider, in which case handset 10 transmits its current location to the wireless service provider, which performs the comparison of the location to the GPS location database 29 and then transmits back a signal indicating whether handset 10 is in an inappropriate calling location. Upon receipt of this signal, controller/processor 20 then either activates the answer-and-wait mode or does not. In either case, this GPS location mode automatically activates the answer-and-wait mode in process 30, eliminating the possibility that the user may forget to activate this mode, or not realize that he or she is in an inappropriate location for a wireless telephone call.

Referring now to FIG. 4, another alternative manner of performing activation process 30 is illustrated. FIG. 4 illustrates handset 10, constructed according to this invention, in the proximity of wireless access point (WAP) 50. WAP 50, in this example, operates according to one of the well-known IEEE 802.11 wireless communications standards, as used in wireless local area networks (LANs). WAP 50 may itself be part of a wireless LAN and have this additional functionality, or alternatively WAP 50 may be a special purpose or dedicated function that is placed by the premises owner into certain rooms, so that handsets such as handset 10 can be placed in the answer-and-wait mode as described in this specification. According to this alternative implementation, WAP 50 is programmed or enabled to issue an RF signal that can be received by handsets such as handset 10, and that indicates that the receiving handset 10 is in a location that is inappropriate for telephone calls. This RF signal preferably is coded, or sent over a dedicated frequency, so that it does not jam wireless telephone communications. This indication transmitted by WAP 50 instructs controller/processor 20 in handset 10 to activate the answer-and-wait mode, effecting process 30. As shown in FIG. 4, handset 10 is still able to carry out communications with the wireless telephone communications network, as is important in executing the answer-and-wait mode function, as will become apparent from the following description.

Alternatively, the GPS locating function or wireless access point function described above may not automatically perform activation process 30 itself, but may instead alert the user that he or she is in a location that is inappropriate for wireless telephone conversations. The user may then choose to manually activate the answer-and-wait mode in the manner described above.

Referring back to FIG. 3, once the answer-and-wait mode is activated in process 30, handset 10 is capable of receiving incoming telephone calls. In this example, such an incoming call is received by handset 10 in process 32, in response to which controller/processor 20 causes handset 10 to ring, in process 34. The manner in which ring process 34 is carried out may depend upon the particular profile or mode that the user has currently selected (i.e., normal, silent, vibrate, etc.), or alternatively activation process 30 may itself place handset 10 into a non-audible ring mode.

The ring of process 34 alerts the user of handset 10 of the incoming call. Preferably, the user will view Caller ID information displayed by controller/processor 20 on visual display 12, to determine whether he or she wishes to take the incoming call, based on the identity of the caller. According to the preferred embodiment of the invention, if the user determines that he or she wants to take the call, but does not want to engage in the conversation in his or her current location (because it would be inappropriate to do so), the user actuates the answer-and-wait function of handset 10. Referring back to FIG. 1, this actuation is accomplished by the user pressing wait key 14 at keypad 13; the particulars of this operation may of course differ, depending on the manner in which wait key 14 is implemented, as mentioned above. For other calls, the user may either wish to immediately take the call in the normal manner (i.e., not by way of the answer-and-wait function). For these calls, the user will not actuate the wait function, by pressing wait key 14 or otherwise.

In decision 35, controller/processor 20 determines whether the answer-and-wait function was actuated by the user. If not (decision 35 is NO), controller/processor 20 determines, in decision 37, whether the call was answered by the user in the normal manner (i.e., by the user pressing an on-hook key, or the like). This may occur in those situations where the user wishes to immediately take the call, regardless of his or her current location. If the call is answered (decision 37 is YES), controller/processor 20 opens the microphone and speaker in process 40, and the call is processed by handset 10 in the normal manner. On the other hand, if the call is not answered (decision 37 is NO), as may be determined by a specified number of rings having been issued by handset 10, controller/processor 20 forwards the call to the operative voice mail system in process 38; typically, this is accomplished by the wireless telephone service provider detecting that the call was not answered within the specified number of rings, in response to which the service provider forwards the caller to the mailbox of its voice mail system that corresponds to handset 10.

If, on the other hand, the answer-and-wait function of handset 10 is actuated by the user, decision 35 returns a YES result. In process 42, controller/processor 20 then causes handset 10 to answer the incoming call. But according to this preferred embodiment of the invention, rather than requiring the user to speak into handset 10 in order to notify the caller that the call has been answered, controller/processor 20 performs process 43 to play a “wait” message that is audible by the caller. The “wait” message preferably notifies the caller to hold the line for a brief time until the user of handset 10 joins the call (i.e., once leaving the inappropriate location). Process 43 can be executed locally by handset 10, for example by transmitting a pre-recorded message stored at handset 10; alternatively, process 43 may be performed by handset 10 transmitting a “wait” signal to the wireless telephone service provider, which then forwards the wait message to the calling party, in similar fashion as voice mail messages are transmitted by the service provider to calling parties for conventional wireless telephony.

Controller/processor 20 in handset 10 then enters a wait loop to permit the user to move to an appropriate location to take the incoming call, which will be indicated by the user again pressing wait key 14, or pressing a different dedicated or dual-function key of keypad 13 (e.g., a key indicated by a menu displayed on display 12), to initiate the call. This loop begins with decision 44, in which controller/processor 20 determines whether the call has been picked up (e.g., by the user again pressing wait key 14). If so (decision 44 is YES), controller/processor 20 opens the microphone and speaker in process 40, and the call is processed by handset 10 in the normal manner. If not (decision 44 is NO), controller/processor 20 executes decision 45 to determine whether the wait state should be maintained. According to the preferred embodiment of the invention, it is contemplated that the user may be able to immediately terminate the wait state and transfer the incoming call to voice mail, for example if the user discovers that he or she cannot leave the inappropriate location; this termination may be effected by the user pressing the off-hook key of keypad 13, or another key as may be indicated by a menu on visual display 12. Also, according to the preferred embodiment of the invention, a timeout period may be specified, and monitored during the wait state, either by controller/processor 20 or by the wireless telephone service provider; upon elapse of the timeout period, the wait state may then also be terminated. If the wait state is neither terminated nor the timeout period yet elapsed (decision 45 is NO), then the wait message continues to be played (process 43), and decisions 44, 45 again executed to determine whether the call has been picked up, terminated, or timed out. On the other hand, if the wait state is terminated or times out (decision 45 is YES), the caller is then forwarded to voice mail, in process 38.

Of course, the caller may hang up at any point during the wait state. In this event, the call will terminate in the usual course.

According to the preferred embodiment of this invention, therefore, significant advantages in the use of wireless telephones are provided. The recipient of a call becomes able, through this invention, to politely take important incoming calls even when the recipient is at a location where it is impolite or distracting to otherwise receive the call. The other persons at that location are therefore not bothered by others engaging in one-sided wireless telephone conversations. The caller receives a message that politely indicates that the call will be answered shortly by the intended recipient, reducing the frustration that often occurs when calls are forwarded to voice mail. According to other aspects of the invention, the answer-and-wait mode can be automatically enabled, for example by GPS positioning of the handset or in response to a wireless signal.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

1. A wireless telephone handset, comprising:
a housing;
a keypad disposed at a face of the housing, the keypad including a plurality of keys;
a speaker;
a microphone;
communications circuitry, for transmitting audio signals over a wireless telephone communications network responsive to inputs to the microphone and keypad, and for outputting audio signals from the speaker responsive to signals received over the wireless telephone communications network; and
control circuitry, coupled to the communications circuitry and to the keypad, for controlling the operation of the handset so that, in response to an incoming call from a caller, and responsive to an input from the keypad, the communications circuitry answers the incoming call and transmits a signal corresponding to a wait message to the caller.

2. The handset of claim 1, further comprising:
a visual display at the face of the housing;
wherein the control circuitry is also for displaying identification information regarding the caller on the visual display responsive to the incoming call.

3. The handset of claim 1, wherein the communications circuitry comprises:
an antenna;
radio frequency circuitry, coupled to the antenna; and
baseband processing circuitry, coupled to the radio frequency circuitry and to the microphone and speaker.

4. The handset of claim 3, wherein the communications circuitry further comprises:
a digital signal processor, coupled to the baseband processing circuitry.

5. The handset of claim 1, wherein the control circuitry is also for activating a selected one of a plurality of operating modes for the handset.

6. The handset of claim 5, wherein one of the plurality of operating modes is an answer-and-wait mode;
and wherein the control circuitry controls the communications circuitry to answer the incoming call and transmits a signal corresponding to a wait message to the caller responsive to the input from the keypad when the answer-and-wait operating mode is activated.

7. The handset of claim 6, further comprising:
a global positioning system receiver, for determining a current location of the handset;
a memory for storing a global positioning system location database;
and wherein the control circuitry is also for comparing the current location with entries in the global positioning system database, and for activating the answer-and-wait operating mode responsive to the current location corresponding to an entry in the global positioning system database indicating that wireless telephone calls are inappropriate.

8. The handset of claim 6, wherein the communications circuitry is also for receiving a wireless control signal indicating that the handset is in a location in which wireless telephone calls are inappropriate;
and wherein the control circuitry is for activating the answer-and-wait operating mode responsive to the communications circuitry receiving a control signal indicating that the handset is in a location in which wireless telephone calls are inappropriate.

9. The handset of claim 8, further comprising:
a global positioning system receiver, for determining a current location of the handset;
wherein the communications circuitry is for transmitting a signal corresponding to the current location of the handset, and for receiving the wireless control signal regarding whether the handset is in a location in which wireless telephone calls are inappropriate;
and wherein the control circuitry is for activating the answer-and-wait operating mode responsive to the communications circuitry receiving the wireless control signal indicating that the handset is in a location in which wireless telephone calls are inappropriate.

10. A method of operating a wireless telephone handset, comprising the steps of:
receiving an incoming wireless call from a caller;
activating a ring function to alert a user that an incoming wireless call is being received;
responsive to receiving an input from a keypad of the handset, answering the incoming wireless call;
then initiating a wait message to be transmitted to the caller;
then, responsive to receiving an input from the keypad indicating acceptance of the call, enabling the handset to receive and transmit signals from and to the caller via the incoming wireless call.

11. The method of claim 10, further comprising:
responsive to the receiving step, displaying caller identification regarding the caller at a visual display of the handset.

12. The method of claim 10, further comprising:
responsive to an input from the keypad, activating an answer-and-wait mode;
wherein the steps of answering the incoming wireless call and then initiating a wait message are performed responsive to the activating of the answer-and-wait mode.

13. The method of claim 10, wherein the activating step comprises:
receiving an input from the keypad indicating that the answer-and-wait mode is to be activated.

14. The method of claim 10, wherein the activating step comprises:
receiving a wireless signal indicating that the answer-and-wait mode is to be activated.

15. The method of claim 10, wherein the activating step comprises:
operating a global positioning system receiver to determine a current location of the handset;
comparing the current location of the handset with a database of locations that the answer-and-wait mode is to be activated; and
activating the answer-and-wait mode responsive to the comparing step determining that the current location of the handset is a location in which the answer-and-wait mode is to be activated.

16. The method of claim 10, further comprising:
responsive to receiving an input from the keypad indicating refusal of the call, forwarding the incoming wireless call to a voice mail system.

17. The method of claim 10, further comprising:
responsive to the elapsing of a timeout period prior to receiving the input from the keypad indicating acceptance of the call, forwarding the incoming wireless call to a voice mail system.

18. The method of claim 10, wherein the step of initiating a wait message comprises:
transmitting a pre-recorded wait message from the handset to the caller over the wireless telephone network.

19. The method of claim 10, wherein the step of initiating a wait message comprises:
transmitting a wait request signal to a wireless telephone service provider, over the wireless telephone network, the wait request signal requesting the wireless telephone service provider to transmit the wait message to the caller.
